(19) United States
(12) Patent Application Publication
(10) Pub. No.: US 2025/0175275 A1
(43) Pub. Date: May 29, 2025

(54) SYSTEMS AND METHODS FOR AI-GUIDED LIVE EVENT AUDIO MIXING

(71) Applicant: Mixhalo Corp., San Francisco, CA (US)

(72) Inventor: Vikram Singh, San Francisco, CA (US)

(21) Appl. No.: 18/961,826

(22) Filed: Nov. 27, 2024

Related U.S. Application Data
(60) Provisional application No. 63/603,876, filed on Nov. 29, 2023.

(51) Int. Cl. H04H 60/07; H04H 60/58

(52) U.S. Cl. CPC H04H 60/07; H04H 60/58

(57) ABSTRACT

A method for AI/ML-guided live event audio mixing includes receiving a data representation of a live audio signal corresponding to a live event via a wireless network. The method also includes processing the data representation of the live audio signal corresponding to the live event into a live audio stream having audio mixes. The method also includes initiating playback of the live audio stream based on a first mix via a headphone communicatively coupled to a mobile computing device at the live event. The method also includes determining a second mix based on a duration since a beginning of the live event and an AI/ML algorithm. The method also includes initiating playback of the live audio stream based on the determined second mix via the headphone communicatively coupled to the mobile computing device at the live event.

### RELATED APPLICATION(S)

This application claims priority to U.S. Provisional Patent Application No. 63/603,876, filed on Nov. 29, 2023, the entire disclosure of which is incorporated herein by reference.

### FIELD OF THE INVENTION

This invention relates generally to the field of real-time delivery of data, such as audio, over wireless networks. More specifically, the invention relates to systems and methods for live event audio mixing based on artificial intelligence/machine learning (AI/ML) techniques.

### BACKGROUND

Attendees of live events often bring and use their mobile computing device to stream data (e.g., audio or video) using at least one of the available wireless networks at the venue (e.g., Wi-Fi™ or cellular). For example, attendees may choose to listen to an audio stream related to the live event using their mobile computing devices. The audio stream may have different channels or “mixes” available for the attendee to choose from. However, attendees may not know which channel or “mix” is the best option at any given moment during the live event. Therefore, there is a need for systems and methods that allow for automated switching from one channel or mix to another when appropriate and without user input.

### SUMMARY

In one aspect, the invention includes a computerized method for AI/ML-guided live event audio mixing. The computerized method includes receiving, by a mobile computing device at a live event, a data representation of a live audio signal corresponding to the live event via a wireless network. The computerized method also includes processing, by the mobile computing device at the live event, the data representation of the live audio signal corresponding to the live event into a live audio stream, the live audio stream including audio mixes.

The computerized method also includes initiating, by the mobile computing device at the live event, playback of the live audio stream based on a first mix via a headphone communicatively coupled to the mobile computing device at the live event. The computerized method also includes determining, by the mobile computing device at the live event, a second mix based on a duration since a beginning of the live event and an AI/ML algorithm. The computerized method also includes initiating, by the mobile computing device at the live event, playback of the live audio stream based on the determined second mix via the headphone communicatively coupled to the mobile computing device at the live event.

In some embodiments, the computerized method further includes receiving, by the mobile computing device at the live event, the data representation of the live audio signal corresponding to the live event from an audio server computing device via the wireless network.

In some embodiments, the computerized method further includes determining, by the mobile computing device at the live event, a third mix based on the duration since the beginning of the live event and the AI/ML algorithm. For example, in some embodiments, the computerized method further includes initiating, by the mobile computing device at the live event, playback of the live audio stream based on the determined third mix via the headphone communicatively coupled to the mobile computing device at the live event.

In some embodiments, the AI/ML algorithm is trained based on historical data corresponding to a performer of the live event.

In another aspect, the invention includes a mobile computing device at a live event for AI/ML-guided live event audio mixing. The mobile computing device is configured to receive a data representation of a live audio signal corresponding to the live event via a wireless network. The mobile computing device is also configured to process the data representation of the live audio signal corresponding to the live event into a live audio stream, the live audio stream including audio mixes.

The mobile computing device is also configured to initiate playback of the live audio stream based on a first mix via a headphone communicatively coupled to the mobile computing device at the live event. The mobile computing device is also configured to determine a second mix based on a duration since a beginning of the live event and an AI/ML algorithm. The mobile computing device is also configured to initiate playback of the live audio stream based on the determined second mix via the headphone communicatively coupled to the mobile computing device at the live event.

In some embodiments, the mobile computing device is also configured to receive the data representation of the live audio signal corresponding to the live event from an audio server computing device via the wireless network.

In some embodiments, the mobile computing device is also configured to determine a third mix based on the duration since the beginning of the live event and the AI/ML algorithm. For example, in some embodiments, the mobile computing device is also configured to initiate playback of the live audio stream based on the determined third mix via the headphone communicatively coupled to the mobile computing device at the live event.

In some embodiments, the AI/ML algorithm is trained based on historical data corresponding to a performer of the live event.

In another aspect, the invention includes a system for AI/ML-guided live event audio mixing. The system includes a mobile computing device communicatively coupled to an audio server computing device over a wireless network. The mobile computing device is configured to receive a data representation of a live audio signal corresponding to the live event via the wireless network. The mobile computing device is also configured to process the data representation of the live audio signal corresponding to the live event into a live audio stream, the live audio stream including audio mixes.

The mobile computing device is also configured to initiate playback of the live audio stream based on a first mix via a headphone communicatively coupled to the mobile computing device at the live event. The mobile computing device is also configured to determine a second mix based on a duration since a beginning of the live event and an AI/ML algorithm. The mobile computing device is also configured to initiate playback of the live audio stream based on the determined second mix via the headphone communicatively coupled to the mobile computing device at the live event.

In some embodiments, the mobile computing device is also configured to receive the data representation of the live audio signal corresponding to the live event from the audio server computing device via the wireless network.

In some embodiments, the mobile computing device is also configured to determine a third mix based on the duration since the beginning of the live event and the AI/ML algorithm. For example, in some embodiments, the mobile computing device is also configured to initiate playback of the live audio stream based on the determined third mix via the headphone communicatively coupled to the mobile computing device at the live event.

In some embodiments, the AI/ML algorithm is trained based on historical data corresponding to a performer of the live event.

These and other aspects of the invention will be more readily understood from the following descriptions of the invention, when taken in conjunction with the accompanying drawings and claims.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a schematic diagram of a system architecture for real-time delivery of live event data over wireless networks, according to an illustrative embodiment of the invention.

FIG. 2 is a schematic diagram of a system architecture for real-time delivery of live event data over wireless networks based on a machine learning algorithm, according to an illustrative embodiment of the invention.

FIG. 3 is a schematic flow diagram illustrating real-time AI/ML-guided live event audio mixing, according to an illustrative embodiment of the invention.

### DETAILED DESCRIPTION

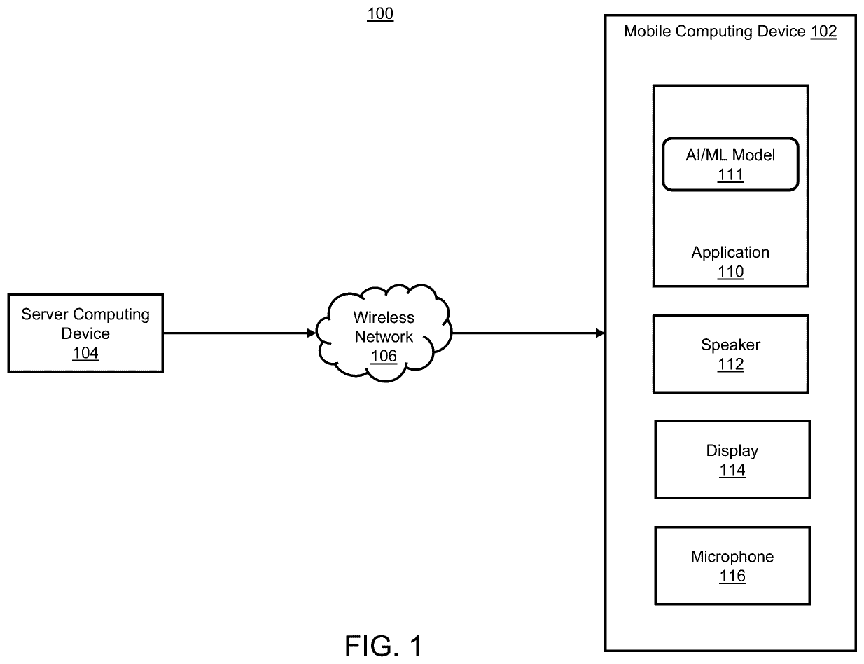

FIG. 1 is a schematic diagram of a system architecture 100 for real-time delivery of live event data over wireless networks, according to an illustrative embodiment of the invention. System 100 includes one or more mobile computing devices 102 communicatively coupled to a server computing device 104 (or audio server computing device) over one or more wireless networks 106. Mobile computing device 102 includes an application 110 with AI/ML model 111, one or more speakers 112, one or more displays 114, and one of more microphones 116. In some embodiments, the server computing device 104 is communicatively coupled to an audio interface (not shown).

Exemplary mobile computing devices 102 include, but are not limited to, tablets and smartphones, such as Apple® iPhone®, iPad® and other iOS®-based devices, and Samsung® Galaxy®, Galaxy Tab™ and other Android™-based devices. It should be appreciated that other types of computing devices capable of connecting to and/or interacting with the components of system 100 can be used without departing from the scope of invention. Although FIG. 1 depicts a single mobile computing device 102, it should be appreciated that system 100 can include a plurality of mobile computing devices.

Mobile computing device 102 is configured to receive a data representation of a live audio signal corresponding to the live event via wireless network 106. For example, in some embodiments, mobile computing device 102 is configured to receive the data representation of the live audio signal corresponding to the live event from server computing device 104 via wireless network 106, where server computing device 104 is coupled to an audio source at the live event (e.g., a soundboard that is capturing live audio). Mobile computing device 102 is also configured to process the data representation of the live audio signal into a live audio stream.

Mobile computing device 102 is also configured to initiate playback of the live audio stream via a first headphone (not shown) communicatively coupled to the mobile computing device 102 at the live event. For example, the user of mobile computing device 102 can connect a headphone to the device via a wired connection (e.g., by plugging the headphone into a jack on the mobile computing device) or via a wireless connection (e.g., pairing the headphone to the mobile computing device via a short-range communication protocol such as Bluetooth®). Mobile computing device 102 can then initiate playback of the live audio stream via the headphone.

Additional detail regarding illustrative technical features of the methods and systems described herein are found in U.S. Pat. No. 11,461,070, titled “Systems and Methods for Providing Real-Time Audio and Data” and issued Oct. 24, 2022, and U.S. Pat. No. 11,625,213, titled “Systems and Methods for Providing Real-Time Audio and Data,” and issued Apr. 11, 2023, the entirety of each of which is incorporated herein by reference.

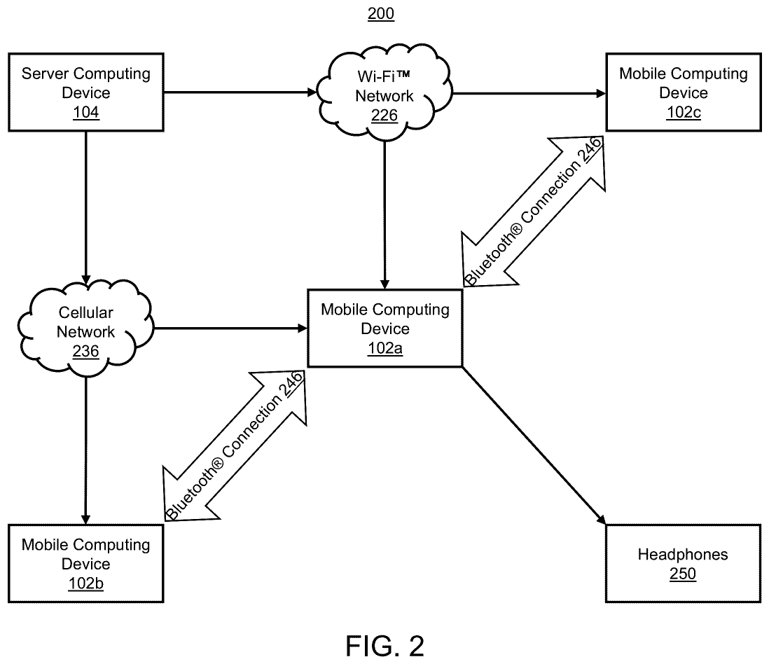

FIG. 2 is a schematic diagram of a system architecture 200 for load balancing of real-time delivery of live event data over wireless networks based on a machine learning algorithm, according to an illustrative embodiment of the invention. System 200 includes a first mobile computing device 102a at a live event communicatively coupled to an audio server computing device 104 over a Wi-Fi™ network 226 or a cellular network 236. System 200 also includes a second mobile computing device 102b at the live event communicatively coupled to the first mobile computing device 102a over a Bluetooth® connection 246 while also being coupled to server computing device 104 via the cellular network 236. In some embodiments, system 200 also includes a third mobile computing device 102c at the live event communicatively coupled to the first mobile computing device 102a over a Bluetooth® connection 246 while also being coupled to server computing device 104 via the Wi-Fi™ network 226.

It should be appreciated that each of the mobile computing devices 102a, 102b, 102c described above can comprise different technical characteristics or features. For example, mobile computing device 102a may comprise an iPhone® running iOS™, mobile computing device 102b may comprise an Android®-based smartphone, and mobile computing device 102c may comprise a Microsoft® Surface™ tablet. The methods and systems described herein advantageously analyze the particular technical characteristics of the mobile computing device, the features of the wireless connection(s) available to the mobile computing device, and changes to those characteristics and features over time, in order to determine which available connection(s) should be used to receive the live audio signal from server computing device 104. As a result, the mobile computing device receives an uninterrupted audio data stream that is automatically adjusted for connection instability and/or device performance constraints in real time without requiring active connection switching by the end user.

The first mobile computing device 102 at the live event is configured to receive a first data representation of a live audio signal corresponding to the live event via a Wi-Fi™ network connection 226. The first mobile computing device 102 at the live event is also configured to receive a second data representation of the live audio signal corresponding to the live event via a cellular network connection 236. The first mobile computing device 102 at the live event is also configured to receive a third data representation of the live audio signal corresponding to the live event from a second mobile computing device 102 at the live event via a Bluetooth® connection 246.

In some embodiments, the first mobile computing device 102 at the live event is further configured to receive the first data representation of the live audio signal corresponding to the live event from the audio server computing device 104 via the Wi-Fi™ network connection 226. In some embodiments, the first mobile computing device 102 at the live event is further configured to receive the second data representation of the live audio signal corresponding to the live event from the audio server computing device 104 via the cellular network connection 236.

In some embodiments, the second or third mobile computing device 102 is configured to receive the third data representation of the live audio signal corresponding to the live event from the audio server computing device 104 via the Wi-Fi™ network connection 226. In other embodiments, the second or third mobile computing device 102 is configured to receive the third data representation of the live audio signal corresponding to the live event from the audio server computing device 104 via the cellular network connection 236.

The first mobile computing device 102 at the live event is also configured to determine whether the first data representation of the live audio signal, the second data representation of the live audio signal, or the third data representation of the live audio signal is being received via an optimal connection using a machine learning algorithm. The first mobile computing device 102 at the live event is also configured to process the first data representation of the live audio signal, the second data representation of the live audio signal, or the third data representation of the live audio signal into a live audio stream based on the determined optimal connection.

In some embodiments, receiving, by the first mobile computing device 102 at the live event, the first data representation of the live audio signal corresponding to the live event via the Wi-Fi™ network connection 226 is associated with a first latency parameter and a first stability parameter. In some embodiments, receiving, by the first mobile computing device 102 at the live event, the second data representation of the live audio signal corresponding to the live event via the cellular network connection 236 is associated with a second latency parameter and a second stability parameter. In some embodiments, receiving, by the first mobile computing device 102 at the live event, the third data representation of the live audio signal corresponding to the live event from the second mobile computing device 102 at the live event via the Bluetooth® connection 246 is associated with a third latency parameter and a third stability parameter.

For example, in some embodiments, the first stability parameter corresponds to a first number of packets lost during a time period, the second stability parameter corresponds to a second number of packets lost during the time period, and the third stability parameter corresponds to a third number of packets lost during the time period. In some embodiments, determining, by the first mobile computing device 102 at the live event, whether the first data representation of the live audio signal, the second data representation of the live audio signal, or the third data representation of the live audio signal is being received via the optimal connection using the machine learning algorithm is based on the first latency parameter, the first stability parameter, the second latency parameter, the second stability parameter, the third latency parameter, and the third stability parameter. Additional details regarding the automatic connection switching technique utilized by system 200 is described in U.S. patent application Ser. No. 18/949,301, titled “Systems and Methods for Real-Time Error Correction of Wireless Data Transmissions,” filed on Nov. 15, 2024, which is incorporated herein by reference.

The first mobile computing device 102 at the live event is also configured to initiate playback of the live audio stream via a headphone 250 communicatively coupled to the first mobile computing device 102 at the live event. In some embodiments, the first mobile computing device 102 at the live event is also configured to initiate playback of the live audio stream via the one or more speakers 112 of the first mobile computing device 102 at the live event.

As can be appreciated, system 100 and/or 200 can be used for multi-mix music deployments during which an AI/ML model 111 incorporated into the application 110 on mobile computing device 102 is trained to ‘listen’ to the audio stream and switch mixes based on the timing of the songs in the set in real-time. In some embodiments, the AI/ML model 111 is trained on historical live performances for a band or artist to identify audio characteristics or audio signatures associated with one or more segments of the performances (e.g., loudness, pitch, timbre, musical phrasing, vocals, instrument types, etc.) and assign a label to each segment that corresponds to a particular audio mix considered to provide an optimal user listening experience for the segment. System 100 and/or 200 can then receive a live audio signal (e.g., from an artist during a live performance), detect audio characteristics or audio signatures of one or more segments of the live audio signal, and process these detected characteristics using the trained AL/ML model to generate a prediction for upcoming segment(s) identifying a particular audio mix that should be activated on mobile computing device 102 and played via headphone to the user during the upcoming segments. For example, the AI/ML model 111 can be trained to inform the mobile computing device application 110 to switch to a guitar mix because a guitar solo is predicted to be coming up in the next 15 seconds. As such, the predictive mixing technique described herein can be considered a “guided” mode for mix swapping.

In some embodiments, the application 110 includes an audio analyzer with two components, a sound classifier and a speech classifier, which are configured to transmit data to AI/ML model 111. The sound classifier is configured to determine contextual data related to sounds based on one or more Signal-to-Noise Ratio (SNR) machine learning models and feed the contextual data to AI/ML model 111 for classification and prediction as described above. Generally, the sound classifier is a software module configured to receive the data representation of the live audio signal from server computing device 104 via wireless network 106, convert the data representation into a live audio stream, and analyze the live audio stream to classify one or more sound-related features of the data representation. In some embodiments, the sound classifier is configured to convert the live audio stream into a format that is usable as input to one or more SNR machine learning models executed by sound classifier. As an example, the sound classifier can partition the data representation of the live audio signal into one or more segments, and for each segment, the sound classifier can convert the live audio stream associated with the segment into, e.g., a multidimensional feature vector that represents one or more sound-related characteristics of the segment. The sound classifier can then process the feature vector(s) using one or more SNR machine learning models to generate a classification output for the segment. For example, the classification output for a given segment can comprise one or more labels that provide contextual data for the segment.

Typically, an SNR machine learning (ML) model is configured to analyze an incoming audio signal and differentiate between tonal aspects of the sound (e.g., voice, musical instruments) and non-tonal aspects (e.g., percussion). As just one example, sound classifier 240 can determine a particular musical key of the segment of the audio stream using the SNR machine learning model processing described above. Other types of classification can include, but are not limited to, tempo (e.g., beats per minute), music style (e.g., rock, jazz, classical, etc.), instrument type (e.g., saxophone, guitar, etc.), loudness, pitch, and timbre. Exemplary SNR music analysis techniques are described in M. Muller et al., “Signal Processing for Music Analysis,” IEEE Journal of Selected Topics in Signal Processing, Vol. 5, Issue 6, October 2011, pp. 1088-1110, which is incorporated by reference herein.

In some embodiments, the sound classifier can utilize multiple ML models to generate the contextual data—including, but not limited to, SNR models (described above), music genre classification models, music information retrieval models, and other types of audio analysis ML models. Exemplary music genre classification techniques that can be used in the sound classifier are described in A. Biswas et al., “Exploring Music Genre Classification: Algorithm Analysis and Deployment Architecture,” arXiv: 2309.04861v2 [cs.SD] Sep. 14, 2023, available at arxiv.org/pdf/2309.04861.pdf, which is incorporated herein by reference. Exemplary music information retrieval techniques that can be used in sound classifier are described in Y. Deldjoo et al., “Content-driven music recommendation: Evolution, state of the art, and challenges,” Computer Science Review, Vol. 51, February 2024, 100618, which is incorporated herein by reference. In some embodiments, the classification output from the SNR machine learning model(s) includes one or more text classification labels and/or one or more numeric classification values.

Similarly, the speech classifier of application 110 is configured to determine contextual data related to speech based on one or more Automatic Speech Recognition (ASR) machine learning models. Generally, the speech classifier is a software module configured to receive the data representation of the live audio signal from server computing device 104 via wireless network 106, convert the data representation into a live audio stream, and analyze the live audio stream to classify one or more speech-related features of the data representation. In some embodiments, the speech classifier is configured to convert the live audio stream into a format that is usable as input to one or more ASR machine learning models executed by the speech classifier. As an example, the speech classifier can partition the live audio stream into one or more segments, and for each segment, the speech classifier can convert the live audio stream associated with the segment into, e.g., a multidimensional feature vector that represents one or more speech-related characteristics of the segment. The speech classifier can then process the feature vector(s) using one or more ASR machine learning models to generate a classification output for the segment. For example, the classification output for a given segment can comprise one or more labels that provide contextual data for the segment. As one example, the speech classifier can transcribe in real-time all or a portion of the speech contained in the live audio stream (such as song lyrics). In another example, the speech classifier can analyze the speech to identify, e.g., a particular band, singer, song title or other characteristics of the performance and/or artist comprised in the live audio signal.

In some embodiments, the speech classifier can be toggled based on specific classification events—for example, when the speech classifier determines that a particular segment of the live audio signal does not contain any speech (e.g., guitar solo), the audio analyzer can toggle the speech classifier off. Exemplary automatic speech recognition techniques that can be used in the speech classifier are described in D. Yu and L. Deng, Automatic Speech Recognition: A Deep Learning Approach, © Springer-Verlag London 2015, and M. Malik et al., “Automatic speech recognition: a survey,” Multimedia Tools and Applications, Vol. 80, pp. 9411-9457 (2021), each of which is incorporated herein by reference. In some embodiments, the sound classifier and the speech classifier operate independently of each other, such that each classifier separately receives the live audio stream and processes the live audio stream in parallel to generate an individual classification for the live audio signal that is transmitted to AI/ML model 111. In some embodiments, the sound classifier and the speech classifier can operate sequentially—for example, the sound classifier can process the live audio stream to generate one or more classifications for the live audio stream and then provide the classifications to the speech classifier, which can incorporate the classifications into its analysis of the data representation (or vice versa). Additional details regarding the operation of the speech classifier and the sound classifier are described in U.S. patent application Ser. No. 18/621,320, titled “Systems and Methods for Real-Time Concert Transcription and User-Captured Video Tagging,” filed on Mar. 29, 2024, which is incorporated herein by reference.

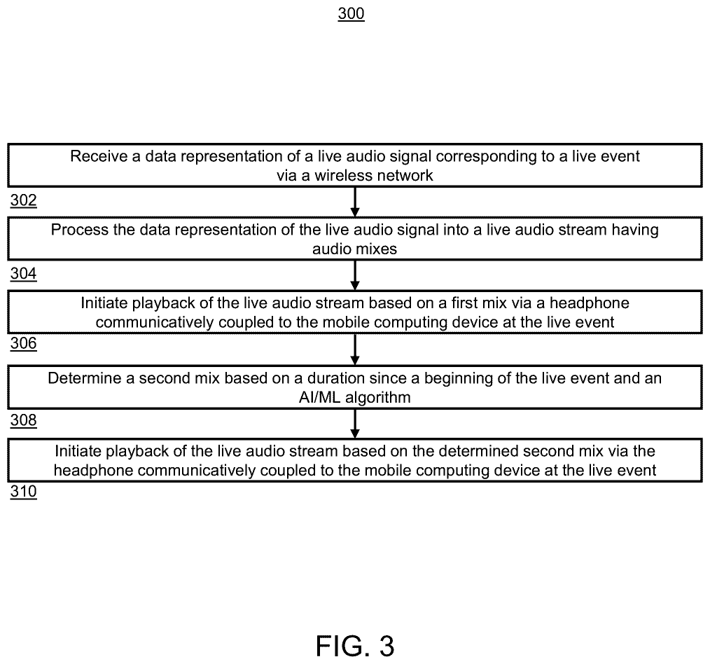

FIG. 3 is a schematic flow diagram illustrating a process 300 for real-time AI/ML-guided live event audio mixing using system 100 and/or 200, according to an illustrative embodiment of the invention. Process 300 begins by receiving, by a mobile computing device 102 at a live event, a data representation of a live audio signal corresponding to the live event via a wireless network 106 at step 302. For example, in some embodiments, process 300 further includes receiving, by the mobile computing device 102 at the live event, the data representation of the live audio signal corresponding to the live event from an audio server computing device 104 via the wireless network 106.

Process 300 continues by processing, by the mobile computing device 102 at the live event, the data representation of the live audio signal corresponding to the live event into a live audio stream, the live audio stream including audio mixes at step 304. Process 300 continues by initiating, by the mobile computing device 102 at the live event, playback of the live audio stream based on a first mix via a headphone communicatively coupled to the mobile computing device 102 at the live event at step 306.

Process 300 continues by determining, by the mobile computing device at the live event, a second mix based on a duration since a beginning of the live event and an AI/ML algorithm at step 308. For example, in some embodiments, the AI/ML algorithm is trained based on historical data corresponding to a performer of the live event as described above.

Process 300 finishes by initiating, by the mobile computing device 102 at the live event, playback of the live audio stream based on the determined second mix via the headphone communicatively coupled to the mobile computing device 102 at the live event at step 310.

In some embodiments, the process 300 further includes determining, by the mobile computing device 102 at the live event, a third mix based on the duration since the beginning of the live event and the AI/ML algorithm. For example, in some embodiments, the process 300 further includes initiating, by the mobile computing device 102 at the live event, playback of the live audio stream based on the determined third mix via the headphone communicatively coupled to the mobile computing device 102 at the live event.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites. The computer program can be deployed in a cloud computing environment (e.g., Amazon® AWS, Microsoft® Azure, IBM® Cloud).

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random-access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD™, HD-DVD™, and Blu-ray™ disks. The processor and the memory can be supplemented by and/or incorporated in special purpose logic circuitry.

To provide for interaction with a user, the above described techniques can be implemented on a computing device in communication with a display device, e.g., a CRT (cathode ray tube), plasma, or LCD (liquid crystal display) monitor, a mobile device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above-described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above-described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth®, near field communications (NFC) network, Wi-Fi™, WiMAX™, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Edge™ available from Microsoft Corporation, and/or Mozilla® Firefox available from Mozilla Corporation). Mobile computing device include, for example, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

The systems and methods described herein can be implemented using supervised learning and/or machine learning algorithms. Supervised learning is the machine learning task of learning a function that maps an input to an output based on example of input-output pairs. It infers a function from labeled training data consisting of a set of training examples. Each example is a pair consisting of an input object and a desired output value. A supervised learning algorithm or machine learning algorithm analyzes the training data and produces an inferred function, which can be used for mapping new examples.

Comprise, include, and/or plural forms of each are open ended and include the listed parts and can include additional parts that are not listed. And/or is open ended and includes one or more of the listed parts and combinations of the listed parts.

While the invention has been particularly shown and described with reference to specific preferred embodiments, it should be understood by those skilled in the art that various changes in form and detail may be made therein without departing from the spirit and scope of the invention as defined by the following claims.

What is claimed is:

1. A computerized method for AI/ML-guided live event audio mixing, the method comprising:
receiving, by a mobile computing device at a live event, a data representation of a live audio signal corresponding to the live event via a wireless network;
processing, by the mobile computing device at the live event, the data representation of the live audio signal corresponding to the live event into a live audio stream, wherein the live audio stream comprises a plurality of audio mixes;
initiating, by the mobile computing device at the live event, playback of the live audio stream based on a first mix of the plurality of audio mixes via a headphone communicatively coupled to the mobile computing device at the live event;
determining, by the mobile computing device at the live event, a second mix of the plurality of audio mixes based on a duration since a beginning of the live event and an AI/ML algorithm; and
initiating, by the mobile computing device at the live event, playback of the live audio stream based on the determined second mix of the plurality of audio mixes via the headphone communicatively coupled to the mobile computing device at the live event.

2. The computerized method of claim 1, further comprising:
receiving, by the mobile computing device at the live event, the data representation of the live audio signal corresponding to the live event from an audio server computing device via the wireless network.

3. The computerized method of claim 1, further comprising:
determining, by the mobile computing device at the live event, a third mix of the plurality of audio mixes based on the duration since the beginning of the live event and the AI/ML algorithm.

4. The computerized method of claim 3, further comprising:
initiating, by the mobile computing device at the live event, playback of the live audio stream based on the determined third mix of the plurality of audio mixes via the headphone communicatively coupled to the mobile computing device at the live event.

5. The computerized method of claim 1, wherein the AI/ML algorithm is trained based on historical data corresponding to a performer of the live event.

6. A mobile computing device at a live event for AI/ML-guided live event audio mixing, the mobile computing device configured to:
receive a data representation of a live audio signal corresponding to the live event via a wireless network;
process the data representation of the live audio signal corresponding to the live event into a live audio stream, wherein the live audio stream comprises a plurality of audio mixes;
initiate playback of the live audio stream based on a first mix of the plurality of audio mixes via a headphone communicatively coupled to the mobile computing device at the live event;
determine a second mix of the plurality of audio mixes based on a duration since a beginning of the live event and an AI/ML algorithm; and
initiate playback of the live audio stream based on the determined second mix of the plurality of audio mixes via the headphone communicatively coupled to the mobile computing device at the live event.

7. The mobile computing device of claim 6, further configured to:
receive the data representation of the live audio signal corresponding to the live event from an audio server computing device via the wireless network.

8. The mobile computing device of claim 6, further configured to:
determine a third mix of the plurality of audio mixes based on the duration since the beginning of the live event and the AI/ML algorithm.

9. The mobile computing device of claim 8, further configured to:
initiate playback of the live audio stream based on the determined third mix of the plurality of audio mixes via the headphone communicatively coupled to the mobile computing device at the live event.

10. The mobile computing device of claim 6, wherein the AI/ML algorithm is trained based on historical data corresponding to a performer of the live event.

11. A system for AI/ML-guided live event audio mixing, the system comprising:
a mobile computing device communicatively coupled to an audio server computing device over a wireless network, the mobile computing device configured to:
receive a data representation of a live audio signal corresponding to the live event via the wireless network;
process the data representation of the live audio signal corresponding to the live event into a live audio stream, wherein the live audio stream comprises a plurality of audio mixes;
initiate playback of the live audio stream based on a first mix of the plurality of audio mixes via a headphone communicatively coupled to the mobile computing device at the live event;
determine a second mix of the plurality of audio mixes based on a duration since a beginning of the live event and an AI/ML algorithm; and
initiate playback of the live audio stream based on the determined second mix of the plurality of audio mixes via the headphone communicatively coupled to the mobile computing device at the live event.

12. The system of claim 11, wherein the mobile computing device is further configured to:
receive the data representation of the live audio signal corresponding to the live event from the audio server computing device via the wireless network.

13. The system of claim 11, wherein the mobile computing device is further configured to:
determine a third mix of the plurality of audio mixes based on the duration since the beginning of the live event and the AI/ML algorithm.

14. The system of claim 13, wherein the mobile computing device is further configured to:
initiate playback of the live audio stream based on the determined third mix of the plurality of audio mixes via the headphone communicatively coupled to the mobile computing device at the live event.

15. The system claim 11, wherein the AI/ML algorithm is trained based on historical data corresponding to a performer of the live event.
